(19) United States
(12) Patent Application Publication
(10) Pub. No.: US 2007/0069485 A1
(43) Pub. Date: Mar. 29, 2007

(54) A Dyeing Art - Studio

(75) Inventor: Edwina Pellikka, Glendale, CA (US)

Correspondence Address: Edwina Pellika, 325 Mira Loma Ave., Glendale, CA, 91204, US

(73) Assignee: Ms.Edwina Pellikka, Glendale, CA (US)

(21) Appl. No.: 11/162,937

(22) Filed: Sep. 28, 2005

(51) Int. Cl. B60S 11/00

(52) U.S. Cl. 280/2

(57) ABSTRACT

This is a one of a kind Art Studio, dedicated to the very high end of hand dyeing, painting, printing and air brushing textiles. On entering the studio from the dock door, on the immediate left is a washing machine for pre-washing small yardages etc. Next there is small “car-wash” machine for rinsing and spinning small items. Then there is a bank of stainless steel vats, two with the capacity of 60 gallons, one twenty gallons, and one 80 gallons. There is also a 60 gallon vat for rinsing only. All the dye vats have steam coils in the bottom connected to the thermostats on the wall, so that the temperature can be regulated at all times. The rinse vat does not need this. There is a small European extractor for delicate items too. Next to the bank of small vats there is a large extractor for spinning out excess water from larger yardage or items. In the middle of the room are two small roller dye vats with the capacity of approximately 240 gallons. There are all managed by hand, and can dye up to about approximately 25 yards of fabric sewn in a loop over the roller so that it is constantly pulled through the dye in the vat beneath. Behind there two vats is a much larger roller machine which, again is hand managed, but has the capacity of 860 gallons of water, and can dye up to 80-100 yards of fabric. (All these have steam coils connected to thermostats). Next to this machine is a big extractor than can spin up to 50-80 yards at one time. Behind the big vat are two large dryers which can handle the large quantity of yardages at one time. They are operated by steam coils. To the right of the middle machines is a separate small room with a two-hour fire wall, which houses the million and a half BTU Parker steam boiler, and 2000 gallon insulated water tank, which is kept at 120 degrees Fahrenheit. The steam boiler regulates all the temperatures in the steam coils for the dye vats. Next to this room, at one end is the utility room, and the other end there is a stainless steel tumble machine used for dyeing jeans, linen covers, etc. Next to it is another stainless steel front loading washing machine. To the left of the dryers is the break room for the employees. To the left of that is the dye room where all the dyes and chemicals are kept separate from the rest of the studio. It has its own air intake and out take, so that no dye dust can escape into the main room. It has a door on both sides. In front of this room, to the left of the big roller machine is a bank of three stainless steel sinks used for rinsing and washing of pans and items that have been dyed. Next to this is a “mixing” stainless steel table on which is kept a hot plate and kettles on which the dyes are mixed. The front right as you come into the building has a client lounge and then the inner office. There is a unisex handicap toilet and a men's toilet to the right of the office. All light in this room are special perfect match to real outdoor day light. Behind the dye room, break room and dryers is a wall dividing the dye area from the painting and painting area. Here there is a 24 foot table on which silk-screen hand printing is done, as well as hand painting. At the end of the table there is a six foot Spray Booth, to the left of which are cabinets that store the paints and printing inks. Further back, the silk screens are stored. Opposite the spray booth there is a metal chimney for steaming fabrics. All lights in this area are UV coated to avoid fading from excessive light exposure. All of the equipment in this studio has been designed by the textile artist from over 30 years of experience, and are in the optimum place for convenience and cleanliness, with a heavy eye on health and safety

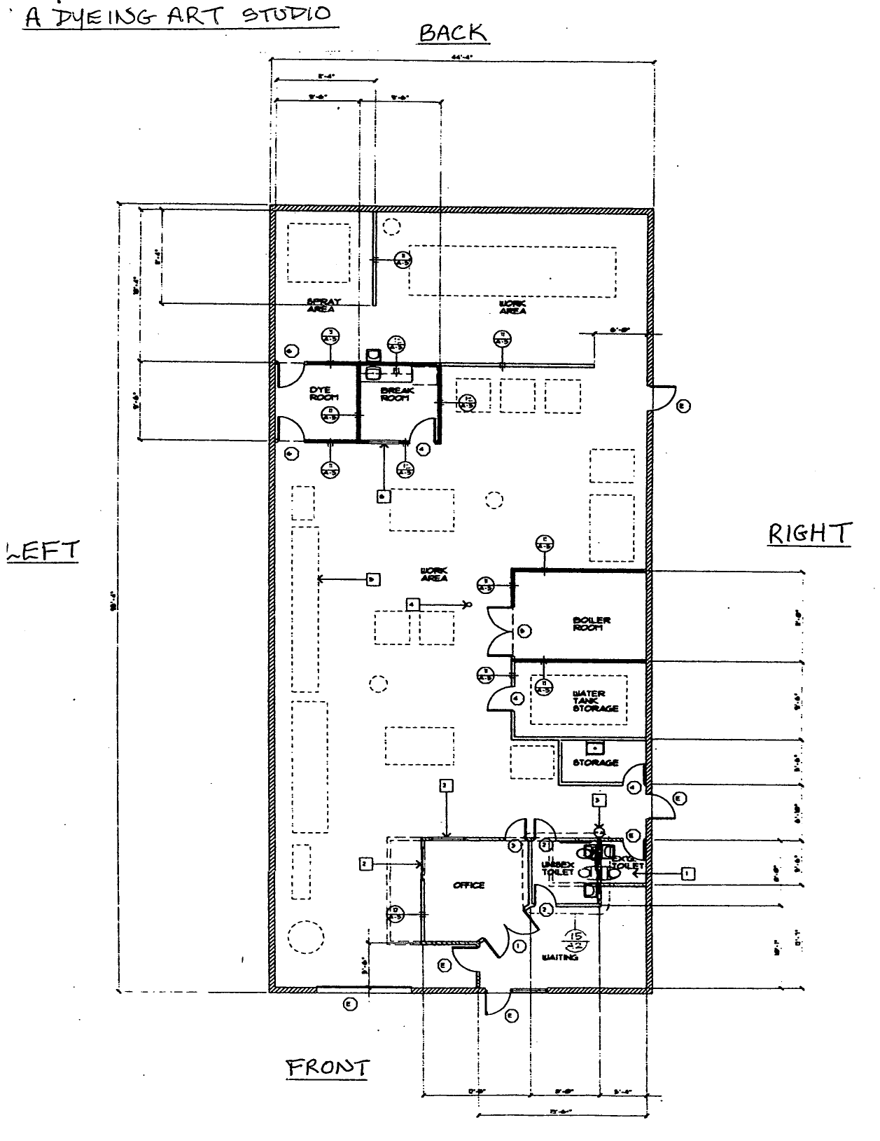

This is a one of a kind Dyeing Art Studio, totally unique in design for optimum treatment of textiles while being completely health and safety conscious: everything being in the most advantageous position for convenience and cleanliness. 4000 square feet entirely devoted to the highest standard of dyeing, painting, printing, air-brushing and ageing of textiles and costumes. A Dyeing Art Studio has been designed and built by the leading textile artist for the entertainment industry, Edwina Pellikka, having over 30 years of international experience in the field. (The primary clientele in the entertainment industry, including film, television, theme parks, music media, opera, theatre, ballet, individual performers; interior design and high-end fashion.) It is one of a kind, having the resources to hand dye fabric from ¼ yard samples up to 100 yard lengths of cloth.

The front of the studio has an office and waiting area on the right. To the left is the large loading door and washing machine, behind which is a small extractor then a bank of four stainless steel dye vats (2×60 gallons, 1×80 gallons, 1×20 gallons, and one rinse vat). Next to this is two medium extractors (for spinning out excess water). Along the same wall is a bank of three stainless steel sinks; followed by a mix table and hot plate. In the middle of the studio are two 240 gallon stainless steel roller dye vats, and an 860 gallon stainless steel roller dye vat for dyeing up to 100 yards at a time. Across the other wall, behind the offices are a unisex, handicap restroom; a men's restroom; a utility storage area, and then a boiler room containing a 2000 gallon water tank and steam boiler. Next are a large tumble washing machine and a stainless steel front-loading washing machine. In front of a partition dividing off the back room, there are two large dryers, next to which are the break room for the staff, and then the dye room. In front of the dryers is an extra large extractor for spinning over 50 yards of fabric. Behind the partition wall is the print and paint area. There is a 24 foot print table in the middle of the room, with stainless steel cabinets either side for storage of tools, paints, paper etc. There is a compressor and stainless steel steam chimney against the back wall. To the left of these are the six foot spray booth, and more storage for silk screens and inks.

What is claimed is:

1. The design itself, the order of the processes as shown by the schematic, and the specific collection of the processes themselves.
